(19) United States
(12) Patent Application Publication
(10) Pub. No.: US 2009/0102738 A1
(43) Pub. Date: Apr. 23, 2009

(54) Antenna Having Unitary Radiating And Grounding Structure

(75) Inventor: Michael F. Bonczyk, McAllen, TX (US)

Correspondence Address: WELSH & KATZ - COMMSCOPE, INC., 120 S. RIVERSIDE PLAZA, 22ND FLOOR, CHICAGO, IL, 60606, US

(73) Assignee: ANDREW CORPORATION, Chicago, IL (US)

(21) Appl. No.: 11/875,299

(22) Filed: Oct. 19, 2007

(51) Int. Cl. H01Q 1/38; H01P 11/00; H01Q 1/48

(52) U.S. Cl. 343/846; 343/700 MS; 29/600

(57) ABSTRACT

An antenna includes radiating elements and a ground structure formed as a single unitary conductive member, the radiating elements extending from the ground structure such that some of the radiating elements are spaced from the ground structure on a first side thereof, others of the radiating elements being spaced from the ground structure on a second side thereof. The antenna may be an omnidirectional antenna and the single conductive member may be formed as a single metal sheet.

### FIELD OF THE INVENTION

The invention relates to antennas. In particular, the invention relates to antennas in which the grounding structure and radiating elements are formed as a single conductive member.

### BACKGROUND TO THE INVENTION

Omnidirectional antennas generally include a symmetric radiating structure which radiates substantially equally in all azimuthal directions. Such antennas typically include many components and require significant assembly time. This results in high production cost and reduced reliability.

Antennas generally require alignment of radiating elements during assembly. This is a time-consuming task and the resultant alignment is often inaccurate. The disadvantages caused by inaccurate alignment are particularly problematic at high frequencies.

It is an object of the invention to provide an antenna with parts which are easily and accurately aligned.

It is a further object of the invention to provide an antenna with reduced production costs and improved reliability.

It is a further object of the invention to provide an antenna with intrinsically grounded radiating elements for improved performance and lightning protection.

### Exemplary Embodiments

There is provided an antenna having one or more radiating elements and a ground structure. The radiating elements and ground structure are formed as a single unitary conductive member. There is also provided a method of forming such an antenna.

In a first exemplary embodiment there is provided an antenna including one or more radiating elements and a ground structure formed as a single unitary conductive member, wherein: a first set of the radiating elements is spaced from the ground structure on a first side of the ground structure; and a second set of the radiating elements is spaced from the ground structure on a second side of the ground structure opposite the first side.

In a second exemplary embodiment there is provided a method of forming an antenna, including: forming a ground structure; forming a first set of one or more radiating elements spaced from the ground structure on a first side of the ground structure; forming a second set of one or more radiating elements spaced from the ground structure on a second side of the ground structure; wherein the radiating elements and the ground structure are formed as a single unitary conductive member.

In a third exemplary embodiment there is provided an omnidirectional antenna including one or more radiating elements and a ground structure, the radiating elements and ground structure being formed as a single unitary conductive member.

In a fourth exemplary embodiment there is provided an antenna including a ground structure and one or more non-planar radiating elements formed as a single unitary conductive member.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 is a perspective view of a section of an antenna according to one embodiment;

FIG. 2A is a side view of the antenna of FIG. 1;

FIG. 2B is a second side view of the antenna of FIG. 1;

FIG. 2C is a further perspective view of the antenna of FIG. 1;

FIG. 2D is an end view of the antenna of FIG. 1;

FIG. 2E is a cut-away perspective view of the antenna of FIG. 1, showing the feed structure from a first side of the central grounding structure;

FIG. 2F is a cut-away plan view of the antenna of FIG. 1, showing the feed structure from a second side of the central grounding structure;

FIG. 3 is a plan view of a radiating and grounding structure according to a further embodiment;

FIG. 4 shows the radiating and grounding structure of FIG. 3, in a partly formed state;

FIG. 5 is a cross-sectional view of an antenna according to a further embodiment; and

FIG. 6 is a perspective view of an antenna according to a further embodiment.

### DESCRIPTION OF EMBODIMENTS OF THE INVENTION

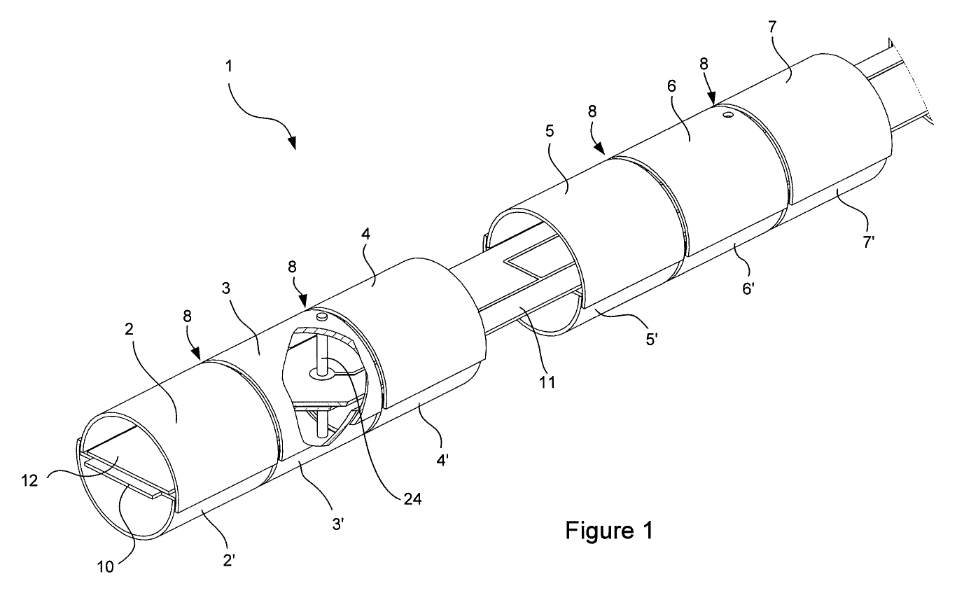

FIG. 1 is a perspective view of a section of an antenna 1 according to one embodiment. This may be an omnidirectional array antenna 1 including a series of radiating elements 2, 2′ to 7, 7′. The radiating elements 2, 2′ to 7, 7′ may be generally cylindrical in form, each radiating element 2, 3, 4, 5, 6, 7 forming substantially half of the cylinder and being opposed by a second radiating element 2′, 3′, 4′, 5′, 6′, 7′ forming substantially the second half of the cylinder. The surface formed by each pair of radiating elements 2, 2′; 3, 3′ etc may be continuous if overlapping elements (e.g. elements 2 and 2′) are soldered together. However, a capacitive coupling approach may involve securing the overlapping sections using a thin doublesided adhesive tape.

The surface of the cylinder may not be continuous along its length, and may be formed with gaps 8 along the length of the cylinder between the radiating elements. The antenna may thus include an array of radiating elements 2, 2′ to 7, 7′.

The antenna 1 may also include a central grounding structure 10 which may run the length of the antenna 1. The radiating elements 2, 2′ to 7, 7′ and the central grounding structure 10 may be formed as a single, unitary conducting member.

The antenna 1 may include a feed structure 11 which may be at least partly formed on a PCB 12 mounted on the grounding structure 10, for transmission of signals between the radiating elements 2, 2′ to 7, 7′ and an external connection.

In use, the radiating elements may act together to form an antenna beam which is substantially uniform in a plane perpendicular to the length of the antenna 1 (for example, an omnidirectional antenna). The beamwidth and the angle of the beam to this plane are determined by the phase and power of radiation from each radiating element. The feed network may be arranged to allow control of the phase and amplitude of signals fed to and/or from the radiating elements. This may allow control of antenna beam downtilt, as well as beamwidth, upper sidelobe suppression and/or nullfill.

The radiating and grounding structure may form a substantially figure-of-eight shape in cross-section, as shown in FIG. 1. The radiating elements form the outside of the figure-of-eight, with the grounding structure forming the middle. The radiating elements may extend from the sides of a central grounding structure. The radiating elements may form a substantially closed structure in cross-section.

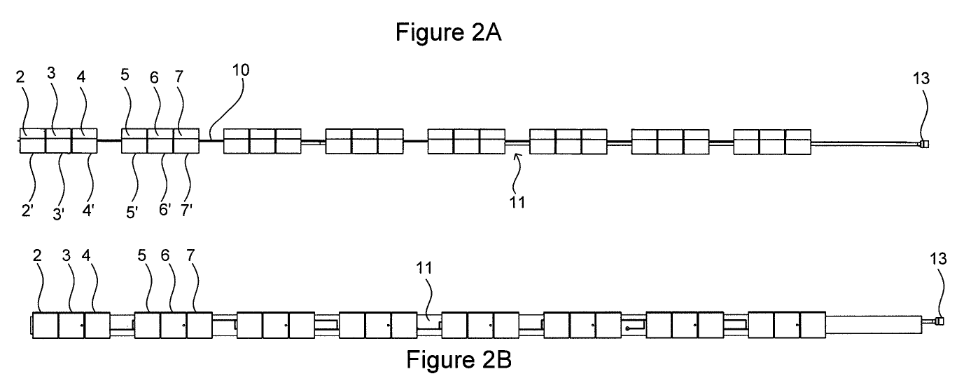

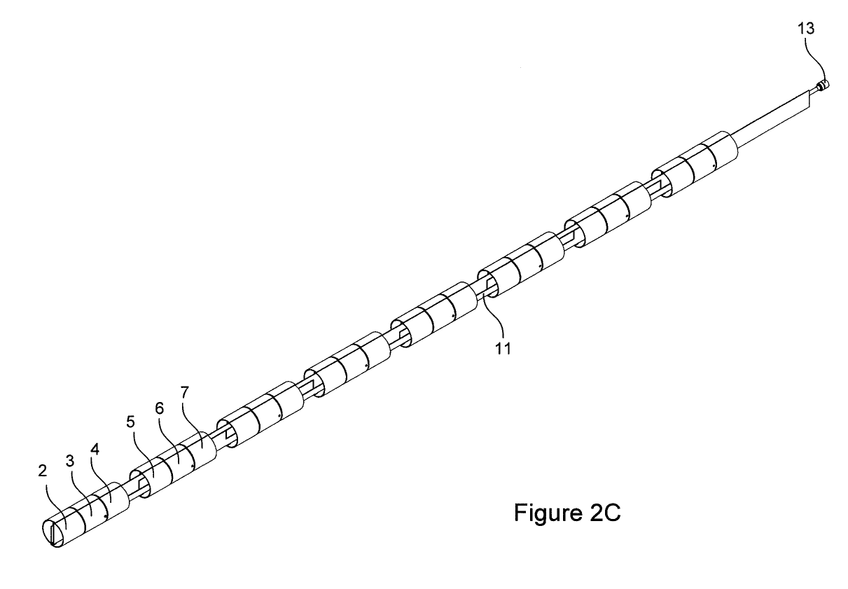

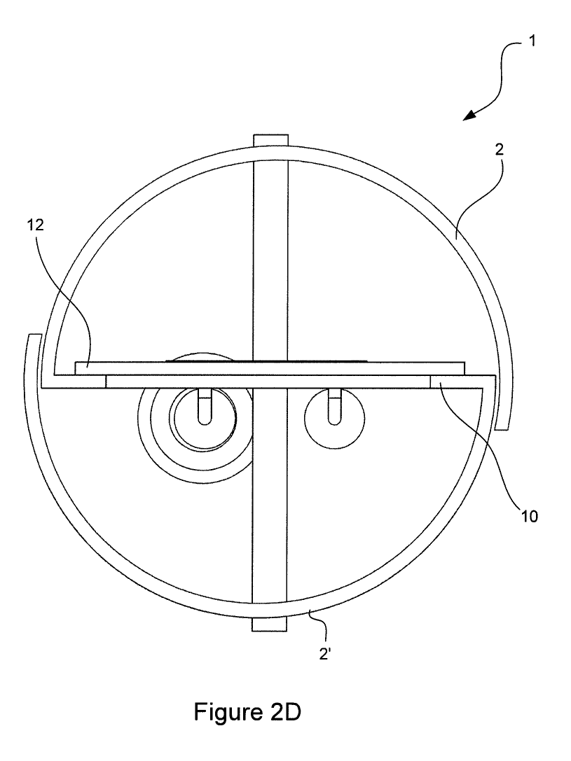

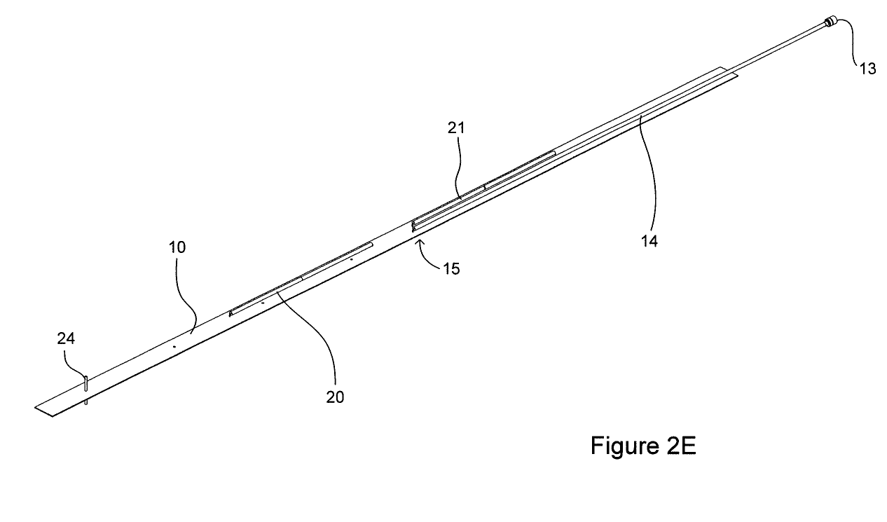

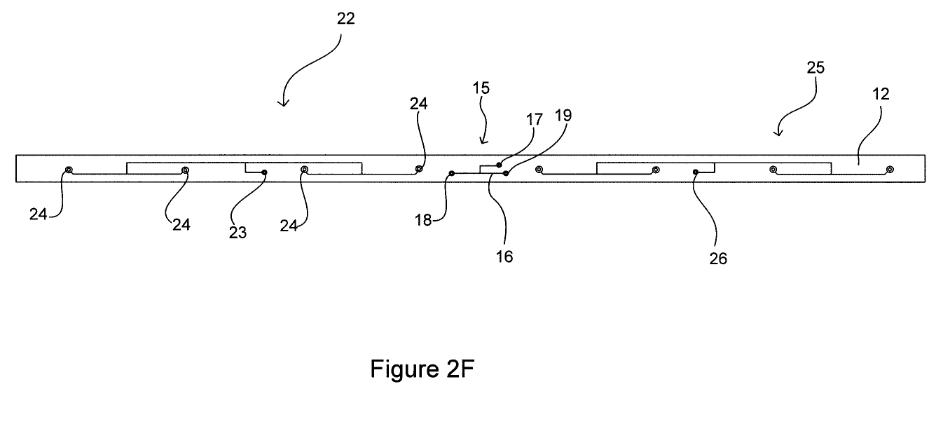

FIG. 2A is a side view of the antenna 1 of FIG. 1, showing the radiating elements 2, 2′ to 7, 7′, central grounding structure 10 and feed arrangement 11. FIG. 2 also shows the external connection 13 for connecting the antenna to external circuitry. FIG. 2B is a further side view of the antenna, at right angles to that of FIG. 2A. FIG. 2C is a perspective view of the antenna of FIGS. 2A and 2B.

FIG. 2D is an end view of the antenna of FIG. 2A, showing the central grounding structure 10 and radiating elements 2, 2′. This figure also shows the feed arrangement, which consists of PCB 12 fed by a coaxial cable in the manner described below.

FIGS. 2E and 2F show a possible feed arrangement 11 of the antenna 1. FIG. 2E shows the feed cables mounted to the central grounding structure, while FIG. 2F shows the feed PCB mounted to the other side of the central grounding structure. The radiating elements are not shown in these figures.

Signals may be supplied to the antenna via external connector 13. Those signals may be supplied via a downlead coaxial cable 14 (FIG. 2E) to a first junction 15. As can be seen in FIG. 2F, the first junction 15 may be formed by a conductive trace 16 which receives signal from the downlead coaxial cable 14 at a coupling point 17. Signal is then split by the junction, passing via coupling points 18, 19 to a top branch cable 20 and a bottom branch cable 21 (FIG. 2E).

The top branch cable then carries signals from the coupling point 18 to an upper feedboard section 22 via a further coupling point 23. The upper feedboard section 22 includes a number of junctions to provide signals to four conductive posts 24. Each post supplies signals to a group of radiating elements. For example, FIG. 1 includes a cut-away section showing a post 24 which feeds signals to radiating elements 3 and 3′. The adjoining elements 2 and 2′, further from the post 24, function as an RF choke. The adjoining elements 4 and 4′, closer to the post 24, function as a groundleg of the radiating element pair.

The bottom branch cable carries signals from coupling point 19 to a lower feedboard section 25 via a further coupling point 26. The lower feedboard section operates similarly to the upper feedboard section.

Each coupling point may be any suitable arrangement for coupling between the feed cable and a conductive trace on a PCB.

The feed arrangement functions in a similar way to gather received signals from the radiating elements and feed them to the external connector 13.

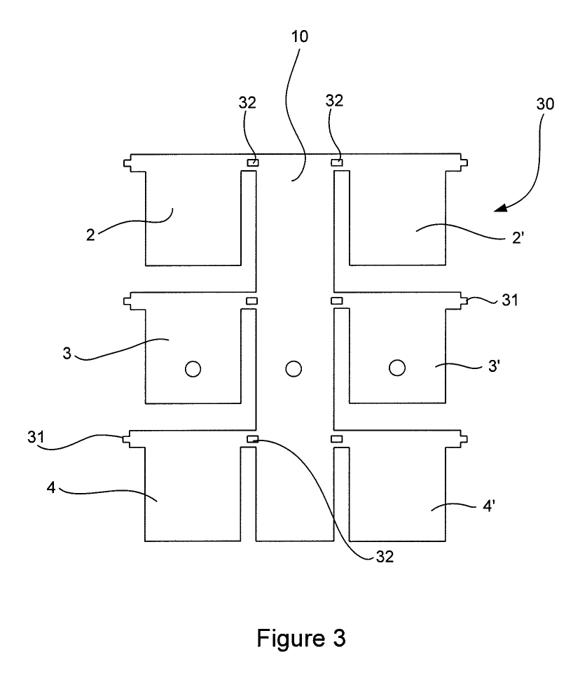

FIG. 3 shows a radiating and grounding structure 30 according to a further embodiment. This structure may be a single, unitary conductive member and may be formed from a single metal sheet, for example. The metal sheet may be stamped and bent using conventional metal-forming techniques, or may be formed in any other suitable manner.

The radiating and grounding structure 30 may form part of an antenna similar to that of FIGS. 1 and 2, although it has only six radiating elements 2, 2′ to 4, 4′ rather than the 48 radiating elements of FIGS. 1 and 2. The radiating and grounding structure 30 includes a central grounding structure 10.

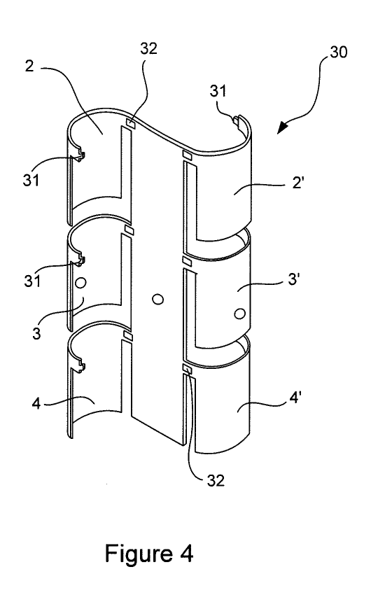

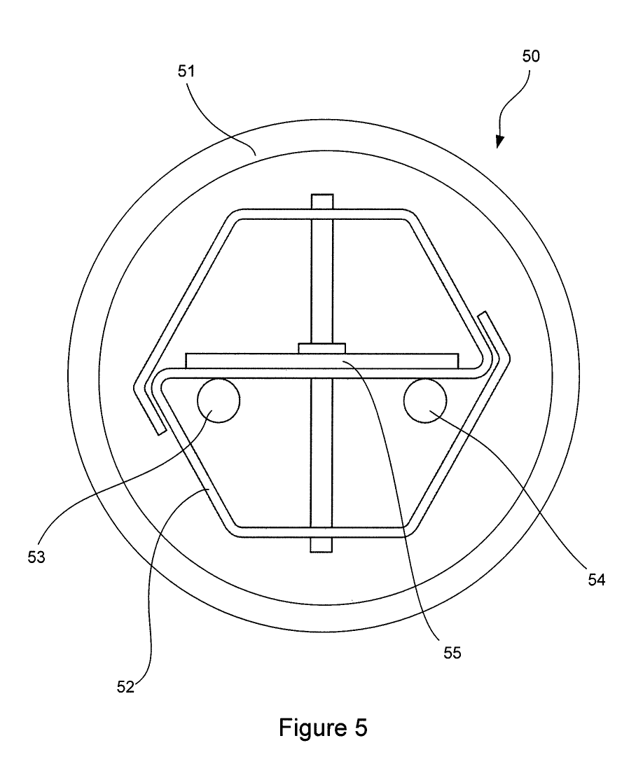

The radiating and grounding structure 30 may be rolled from a flat sheet of metal, as shown in FIG. 3, to a cylindrical form suitable for use in an omnidirectional antenna. FIG. 4 shows the radiating and grounding structure 30 in an intermediate stage of the rolling process. Each set of radiating elements 2, 3, 4; 2′, 3′, 4′ may be rolled in an opposite direction to form the structure 30 into a cylindrical shape with the central grounding structure lying on a diameter of the cylinder.

Each radiating element may include a tab 31 which engages with a slot 32 when the structure 30 has been fully rolled. This provides improved structure and also may provide an electrical connection between the tab 31 and the grounding structure 10. Alternatively, each radiating element may simply overlap the other, as shown in FIGS. 1 to 2E. Where an overlap is used, the two surfaces may be joined using double sided adhesive tape, which provides capacitive coupling between the two surfaces. A soldered joint could be used but is less desirable.

This structure may be formed by stamping or similar process from a metal sheet and then bending using standard sheet metal techniques. The feed components may be attached to the grounding structure before or after bending.

The feed components may include a coaxial feed and/or microstrip feed and/or printed circuit board (PCB) feed. Where a PCB is used, this will contribute to the rigidity of the assembled antenna.

A similar antenna may be formed using a metallized planar substrate to form the radiating and grounding structure. For example, a Mylar film could be metallized, before or after cutting the film appropriately, and then rolled. Alternatively, a flexible material having a conductive layer encapsulated in film could be used.

FIG. 5 is a cross-sectional view of an antenna 50 according to a further embodiment, contained within a cylindrical radome 51. Rather than the cylindrical cross-section of the radiating structures of FIGS. 1 to 4, this antenna has a hexagonal structure. The radiating and grounding structure 52 may be similar to that of FIG. 3, but is then bent to form a hexagonal tubular form, rather than a cylindrical form. This view also shows a feed arrangement formed by two cables 53, 54 and a PCB 55. The feed structure may generally be similar to that of FIGS. 1 to 2F.

The hexagonal form may have a superior structure with greater rigidity than a cylindrical structure. The structure could also be improved further by including a number of ribs (not shown) along the wall of the radiating elements to provide further support. These may be formed by stamping or any other suitable method. Ribs may be used with any radiator profile, including a cylindrical profile.

In general, the structure of the radiating elements may form any suitable profile, including cylindrical profiles, polygonal tubular profiles etc.

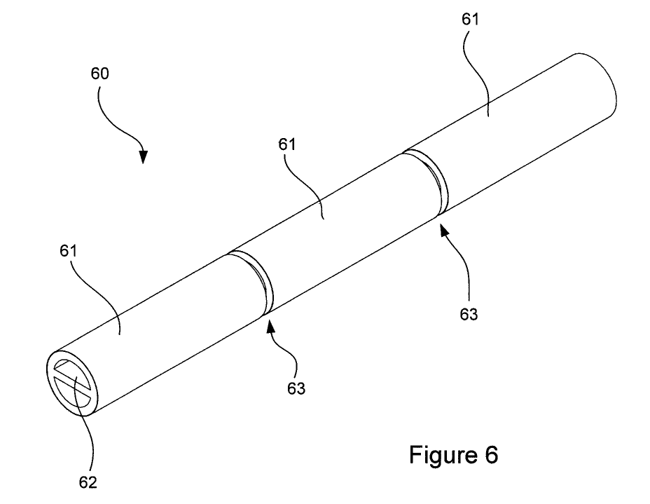

FIG. 6 shows an antenna structure 60 according to a further embodiment. This antenna is formed by creating an antenna form using a dielectric. The antenna form may be formed by extruding, molding or otherwise forming a suitable dielectric material, including plastics etc. The surface of the dielectric form is then metallized, giving a structure including radiating elements 61 and a central grounding structure 62 formed as a single unitary conducting member. The metallization step may be achieved by plating, dipping, vapor deposition or any other suitable process.

The metallization process should establish a stable, reliable bond to the underlying structure. The conductive coating should satisfy any passive inter-modulation requirements, such as being non-magnetic and having continuous conductivity. The metallization process may include the use of masking or other suitable techniques for forming the gaps between radiating elements.

Some machining of the dielectric may be necessary when formed as an extrusion. For example, gaps 63 may need to be machined.

A similar structure can be achieved by forming a suitable dielectric form and then adhering a metal layer to the form. For example, a radiating and grounding structure could be formed in an adhesive-backed metal tape, which is then adhered to the form. A metal foil could be adhered to the form using a suitable adhesive. The tape or foil could be cut by any suitable method, including die cutting.

Similarly, a planar dielectric such as a Mylar film could be metallized and then adhered to an antenna form.

Alternatively, the entire structure shown in FIG. 6 could be formed by extrusion or molding of metal, giving a robust and simple structure. The extrusion could be machined to provide gaps between radiating elements and any other desired features.

The conductive material may be aluminum, for low cost. However, aluminum requires capacitive coupling or compression contacts, so brass may be preferred. Although more expensive, brass offers simpler electrical connections by soldering.

Although the antennas described above have been described principally with respect to transmission of signals, these antennas may also operate to receive signals, as will be readily understood by a skilled reader.

Antennas according to the invention may be suitable for any application requiring broadband omnidirectional radiation, particularly where downtilt and/or nullfill and/or sidelobe suppression are required. The precise tolerances possible make these antennas particularly suitable for high frequency applications.

Antennas according to the invention may be suitable for applications in cellular networks. Antennas according to the invention may be fabricated for a variety of frequency ranges, including wideband frequency ranges. In particular, antennas may be designed for the 2.3 to 2.7 GHz, 3.3 to 3.8 GHz and 1710 to 2180 MHz ranges.

The invention provides antenna structures which are intrinsically grounded. The radiating elements are formed with the grounding structure in a single unitary conductive member. This provides generally improved performance, including good impedance matching and intrinsic lightning protection. Further, this simplifies fabrication, since connections between the radiating elements and grounding structure are not required, eliminating several time-consuming soldering tasks during assembly.

The invention also provides antenna structures which are easily aligned. The radiating elements are properly aligned, either through the bending operation when formed from a metal sheet, metallised dielectric sheet or the like, or by the structure of the form when formed by deposition on an antenna form. In either case, alignment occurs naturally in the course of fabrication, rather than requiring separate time-consuming and potentially inaccurate alignment steps during assembly. This improved alignment results in improved impedance matching. These precise tolerances are particularly valuable at higher frequencies.

The invention also allows spacings to be formed accurately (for example the gaps 8 in FIG. 1). These spacings are effectively predefined by the stamping or cutting operation rather than the assembly operation. This further contributes to the precise tolerances enabled by the invention.

The above advantages result in reduced labor cost, improved electrical performance (including impedance matching) and higher reliability with improved consistency in production.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and methods, and illustrative examples shown and described. Accordingly, departures may be made from such details without departure from the spirit or scope of the Applicant's general inventive concept.

1. An antenna including one or more radiating elements and a ground structure formed as a single unitary conductive member, wherein:
i. a first set of the radiating elements is spaced from the ground structure on a first side of the ground structure; and
ii. a second set of the radiating elements is spaced from the ground structure on a second side of the ground structure opposite the first side.

2. An antenna as claimed in claim 1 being an omnidirectional antenna.

3. An antenna as claimed in claim 1 wherein the ground structure is formed as a central conductive region with the first set of radiating elements extending from a first extremity of the central conductive region and the second set of radiating elements extending from a second extremity of the central conductive region.

4. An antenna as claimed in claim 1 wherein the radiating elements and ground structure form a substantially figure of eight shape in transverse cross-section.

5. An antenna as claimed in claim 1 wherein the radiating elements have a curved profile.

6. An antenna as claimed in claim 1 wherein the radiating elements have a part-polygonal profile.

7. An antenna as claimed in claim 1 further including one or more ribs on the radiating elements for improved structural stability.

8. An antenna as claimed in claim 1 wherein the one or more radiating elements and the ground structure are formed from a single metal sheet.

9. An antenna as claimed in claim 1 wherein the one or more radiating elements and the ground structure are formed from a flexible metallic or metallized sheet mounted to a support embodying the antenna structure.

10. An antenna as claimed in claim 1 wherein the one or more radiating elements and the ground structure are formed from a metallic extrusion.

11. An antenna as claimed in claim 1 wherein the one or more radiating elements and the ground structure are formed from a preformed dielectric embodying the antenna structure and subsequently metallized.

12. An antenna as claimed in claim 1 wherein the conductive member is formed from one of aluminum and brass.

13. An antenna as claimed in claim 1 being a cellular antenna.

14. An antenna as claimed in claim 1 configured to receive and/or transmit in a frequency range from the group of frequency ranges: 2.3 to 2.7 GHz; 3.3 to 3.8 GHz; and 1710 to 2180 MHz.

15. An antenna as claimed in claim 1 further including a feed network configured to feed signals to and/or from the radiating elements and allowing control of phase and/or amplitude of signals fed to and/or from the radiating elements in order to achieve one or more of: adjustable antenna beam downtilt; upper sidelobe suppression; and nullfill.

16. A method of forming an antenna, including:
i. forming a ground structure;
ii. forming a first set of one or more radiating elements spaced from the ground structure on a first side of the ground structure;
iii. forming a second set of one or more radiating elements spaced from the ground structure on a second side of the ground structure;
wherein the radiating elements and the ground structure are formed as a single unitary conductive member.

17. A method as claimed in claim 16 including forming the ground structure as a central conductive region with the first set of radiating elements extending from a first extremity of the central conductive region and the second set of radiating elements extending from a second extremity of the central conductive region.

18. A method as claimed in claim 17 including forming the radiating elements and ground structure into a substantially figure of eight shape in transverse cross-section.

19. A method as claimed in claim 16 including forming one or more ribs on the radiating elements for improved structural stability.

20. A method as claimed in claim 16 including forming the radiating elements and the ground structure from a single metal sheet.

21. A method as claimed in claim 20 including stamping and bending the metal sheet to form the radiating elements and ground structure.

22. A method as claimed in claim 16 including forming the radiating elements and the ground structure from a flexible metallic or metallized sheet mounted to a support embodying the antenna structure.

23. A method as claimed in claim 16 including forming the radiating elements and the ground structure from a metallic extrusion.

24. A method as claimed in claim 16 including forming the radiating elements and the ground structure from a metallized dielectric.

25. A method as claimed in claim 16 further including forming a feed network configured to feed signals to and/or from the radiating elements and allowing control of phase and/or amplitude of signals fed to and/or from the radiating elements.

26. An omnidirectional antenna including one or more radiating elements and a ground structure, the radiating elements and ground structure being formed as a single unitary conductive member.

27. An antenna as claimed in claim 26 wherein the radiating elements have a curved profile.

28. An antenna as claimed in claim 26 wherein the radiating elements have a part-polygonal profile.

29. An antenna as claimed in claim 26 wherein the one or more radiating elements and the ground structure are formed from a single metal sheet.

30. An antenna as claimed in claim 26 wherein the one or more radiating elements and the ground structure are formed from a flexible metallic or metallized sheet mounted to a support embodying the antenna structure.

31. An antenna as claimed in claim 26 wherein the one or more radiating elements and the ground structure are formed from a metallic extrusion.

32. An antenna as claimed in claim 26 wherein the one or more radiating elements and the ground structure are formed from a preformed dielectric embodying the antenna structure and subsequently metallized.

33. An antenna as claimed in claim 26 being a cellular antenna.

34. An antenna as claimed in claim 26 further including a feed network configured to feed signals to and/or from the radiating elements and allowing control of phase and/or amplitude of signals fed to and/or from the radiating elements in order to achieve one or more of: adjustable antenna beam downtilt; upper sidelobe suppression; and nullfill.

35. An antenna including a ground structure and one or more non-planar radiating elements formed as a single unitary conductive member.

36. An antenna as claimed in claim 35 being an omnidirectional antenna.

37. An antenna as claimed in claim 35 wherein the radiating elements have a curved profile.
